(19) United States
(12) Patent Application Publication
(10) Pub. No.: US 2012/0048227 A1
(43) Pub. Date: Mar. 1, 2012

(54) METHOD FOR COATING AN EXHAUST PORT AND APPARATUS FOR PERFORMING THE METHOD

(75) Inventor: Aurélien Tricoire, Trollhattan (SE)

(73) Assignee: VOLVO AERO CORPROATION, Trollhattan (SE)

(21) Appl. No.: 13/130,310

(22) PCT Filed: Nov. 20, 2008
(86) PCT No.: PCT/SE08/00652

§ 371 Date: Jun. 20, 2011

(51) Int. Cl. F02F 1/42; B05D 1/02; B05D 7/00; B05B 17/00

(52) U.S. Cl. 123/193.5; 118/300; 427/256; 118/323

(57) ABSTRACT

A method for coating at least one exhaust port of a cylinder arranged inside a cylinder head of a combustion engine is provided, wherein the exhaust port connects the cylinder to an exhaust system. One or more surface portions of the cylinder head defining the at least one exhaust port are at least partially coated by spraying material from both the cylinder side and the exhaust system side. An apparatus for performing the method is also provided.

### BACKGROUND AND SUMMARY

The invention relates to a method for coating an exhaust port and an apparatus for performing the method.

U.S. Pat. No. 5,987,882 discloses an engine which is coated on various portions with a layer such as a thermally insulating coating. Particularly, the inner surfaces of the exhaust manifold and the pipes prior to the turbocharger and optionally other areas of a cylinder head are coated, thus providing an increased temperature of the exhaust gases which can increase the efficiency of a turbocharger. Various deposition techniques are suggested to apply the coating to the inner surfaces, such as impregnation with a solution of soluble precursor followed by thermal or chemical decomposition, thermal spraying processes such as flame spraying or plasma spraying, or by application of a slurry followed by a thermal treatment to dry. However, an after treatment after a wet coating with a soluble precursor and/or a slurry is time consuming and the handling of the components is laborious. Further, some of the surfaces to be coated exhibit a complex geometry.

It is desirable to provide a method for coating of complex inner surfaces of an exhaust port which provides a reliable deposition of material. It is also desirable to provide an apparatus for performing the method.

A method is proposed for coating at least one exhaust port of a cylinder arranged inside a cylinder head of a combustion engine, wherein the exhaust port connects the cylinder to an exhaust system. One or more surface portions of the cylinder head defining the at least one exhaust port are at least partially coated by spraying material from both the cylinder side and the exhaust system side.

Between inlet and outlet the exhaust port has a curved shape. By coating exhaust port from both sides, it is possible to coat the complicated shape of the exhaust ports with a high coating quality. Compared to other coating techniques such as wet coating and the like, where the cylinder head may have to undergo an after treatment, spray coating can be applied easily and reproducible. A geometrical modification of the engine can be avoided, particularly in the combustion chamber. As the coating is applied to the finished parts, a change in the casting process of the engine parts can be avoided.

A high coverage of the exhaust outlet ports can be achieved by the heat insulating coating which yields a high thermal insulation. Preferably, the coating material can be a thermal barrier coating which reduces or eliminates a heat transfer from the hot exhaust gases to the cylinder head and/or the engine. The material can be sprayed in one global step with thicknesses up to several hundreds of micrometers. The coating can preferably be a thermal barrier coating applied by plasma spraying. Optionally, a basecoat can be deposited before a topcoat is applied. The topcoat preferably is a ceramic heat insulating material, by way of example yttria-stabilized zirconia (Y2O3-ZrO2), as well as magnesia stabilized zirconia (MgO—ZrO2)-, calcia stabilized zirconia (CaO—ZrO2)-, ceria stabilized zirconia (CeO2-ZrO2)-stabilized zirconia (ZrO2-ZrO2), as well as zircon (ZrSiO4), zirconates (such as CaZrO3), titanates (such as CaTiO3) and the like.

Thus, the exhaust gases are at a high temperature when entering a turbocharger. More energy is available for the turbocharger which can provide more energy for driving a compressor for compressing air for the combustion process in the engine.

According to a favourable embodiment of the invention, the at least one exhaust port can coated at least partially by coating separately a first portion and a second portion of the exhaust port. The coating of the exhaust port walls can be performed in a controlled way for each portion of the exhaust port. By coating the inlet and outlet region separately, it is possible to coat the complicated shape of the exhaust ports with a high coating quality.

According to a further favourable embodiment of the invention, the first portion of the exhaust port can be coated by material supplied by a first spray gun. According to a favourable refinement, the first spray gun coating the first portion can be positioned outside the exhaust port. Preferably, material coating the first portion of the exhaust port can be deposited along a direction corresponding to a longitudinal extension of the first spray gun. Favourably, the spray gun can be rotated about an axis arranged crosswise to the spraying direction.

According to a further favourable embodiment of the invention, the second portion of the exhaust port can be coated by material supplied by a second spray gun. According to a favourable improvement, the material for coating the second portion of the exhaust port can be supplied from inside of the exhaust port. Preferably, the material coating the second portion of the exhaust port can be deposited under an angle to a direction corresponding to a longitudinal extension of the second spray gun. Favourably, the second spray gun can be rotated about an axis arranged parallel to its longitudinal extension. The first and the second spray guns can be operative simultaneously or sequentially. A simultaneous operation shortens the process time for coating the one or more exhaust ports. A sequential operation allows for a less complex apparatus for performing the coating of the one or more exhaust ports.

According to a further favourable embodiment of the invention, the material coating the first portion can be deposited with a deposition rate higher than the material coating the second portion. The first portion is subject to a higher thermal load during engine operation so that a thick coating improves a thermal insulation of the exhaust port. Thus it is advantageous according to a further favourable embodiment of the invention that the first portion on the cylinder head fire face side can be coated with a deposition rate higher than coating the second portion on an exhaust manifold side of the exhaust port.

Favourably, the exhaust port can be coated by thermal spraying, preferably by plasma spraying. Thermal or plasma spraying results in a coating on the first and second surface portions with a reliable bonding strength and homogeneity.

According to a further favourable embodiment of the invention, the exhaust port can be treated with a cleaning step prior to coating. A cleaning step can improve the bonding of the coating deposited on the first and second surface portions. Alternatively or additionally, the bond strength of the coating can be further improved by coating the first and second portions with a bond coat prior to coating with a topcoat.

According to further aspect of the invention, an apparatus is proposed for performing coating of an exhaust port. A first spray gun and a second spray gun are provided for deposition of a material at a first and a second portion of an exhaust port of a cylinder head.

According to a favourable embodiment of the invention, a nozzle of the first spray gun can be arranged to deposit material along a direction corresponding to a longitudinal extension of the first spray gun. The spray gun has a simple design spraying in a forward direction.

According to a further favourable embodiment of the invention, a nozzle of the second spray gun can be arranged to deposit material under an angle to a direction corresponding to a longitudinal direction of the second spray gun. This allows depositing material from inside the exhaust port in a sidewise direction.

According to a further favourable embodiment of the invention, the first and/or the second spray guns can be arranged rotatably with respect to the exhaust port. Alternatively, the exhaust port can be arranged rotatably with respect to first and/or the second spray guns. A homogeneous coating thickness can be achieved when rotating the first and/or second spray gun during spray coating.

According to further aspect of the invention, a cylinder head is proposed comprising at least one exhaust port coated with a thermally heat insulating material according to a method where spray coating is performed at least partially of one or more surface portions of the cylinder head defining the at least one exhaust port from both the cylinder side and the exhaust system side.

### BRIEF DESCRIPTION OF THE DRAWINGS

The present invention may best be understood from the following detailed description of the embodiments, but not restricted to the embodiments, wherein is shown schematically:

FIG. 1 an arrangement comprising an engine with a cylinder head, a turbocharger and a catalyst system;

FIG. 2a, 2b a view on a fire face side of the cylinder head (FIG. 2a) and a view on an exhaust manifold side of the cylinder head (FIG. 2b); and

FIG. 3a-3c a longitudinal cut through a exhaust port with a first spray gun depositing material on a first portion of the exhaust port (FIG. 3a), with a second spray gun depositing material on a second portion of the exhaust port (FIG. 3b) according to the invention, and the surface portions to be coated in combination (FIG. 3c).

### DETAILED DESCRIPTION

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

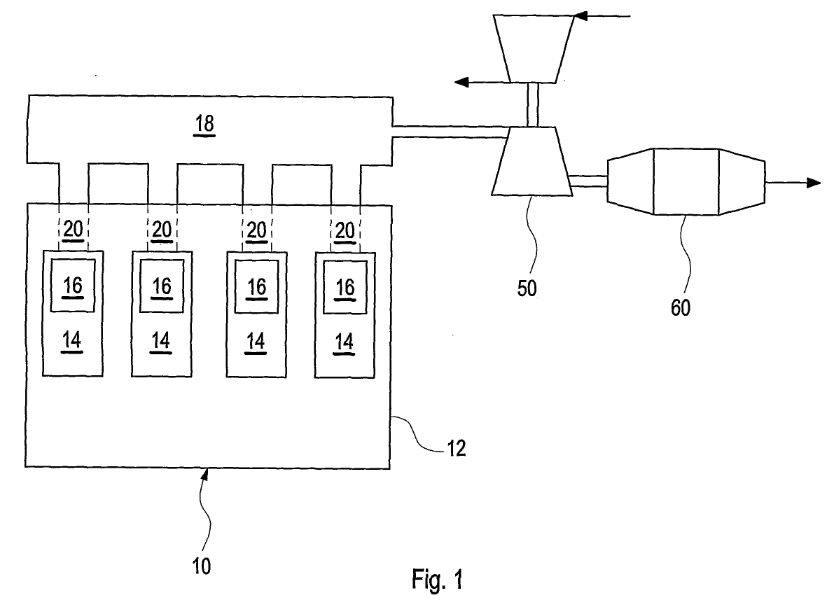

FIG. 1 depicts schematically an arrangement comprising an engine 10 with a cylinder head 12, a turbocharger 50 connected with its turbine side to an exhaust manifold 18 of the engine 10 and an exhaust after treatment system 60 for reducing emissions contained in the exhaust gases. The general setup of such an arrangement is known in the art.

In the cylinder head 12 of the engine 10 a multitude of cylinders 14 is provided in each of which a piston 16 is movable up and down by action of the combustion process in the engine 10 in the usual manner. Exhaust gases generated during combustion are discharged through exhaust ports 20 assigned to each cylinder 14 to the exhaust manifold 18. An exhaust port 20 is a channel defined by the walls of the cylinder head 12.

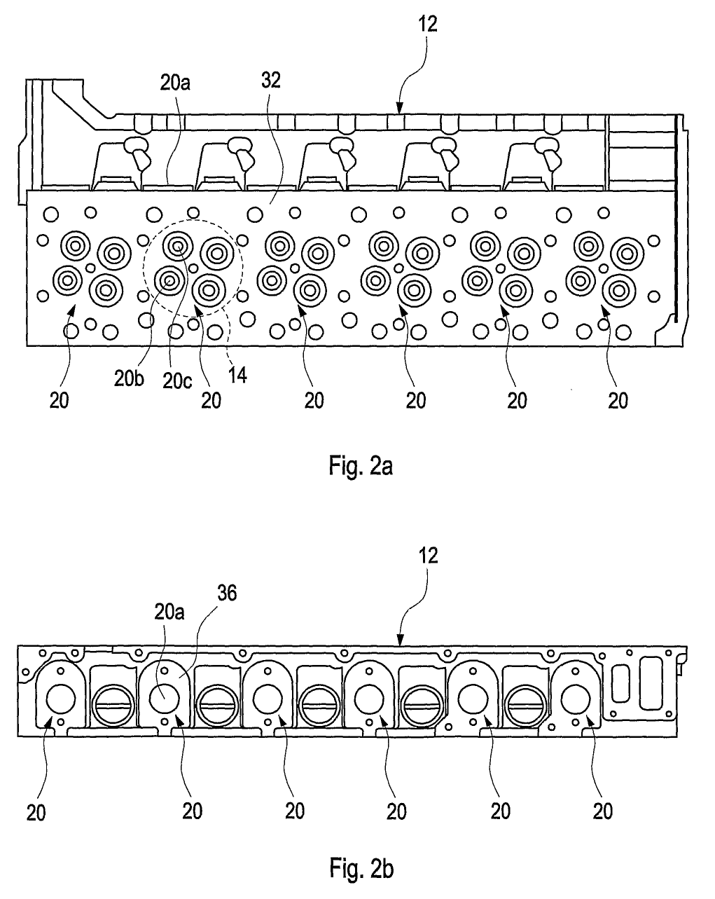

FIG. 2a and FIG. 2b illustrate a view on a fire face side 32 of a cylinder head 12 (FIG. 2a) and a view on an exhaust manifold side 36 of a cylinder head 12 (FIG. 2b) comprising by way of example six cylinders 14, each equipped with an exhaust port 20.

The exhaust ports 20 on the fire face side 32 exhibit two openings 20b, 20c, whereas on the exhaust manifold side 36 the exhaust ports 20 exhibit one opening 20a. Each cylinder 14 (FIG. 1) also exhibits two inlet openings (not referred to with a reference number) for feeding air into the cylinder 14 (FIG. 1).

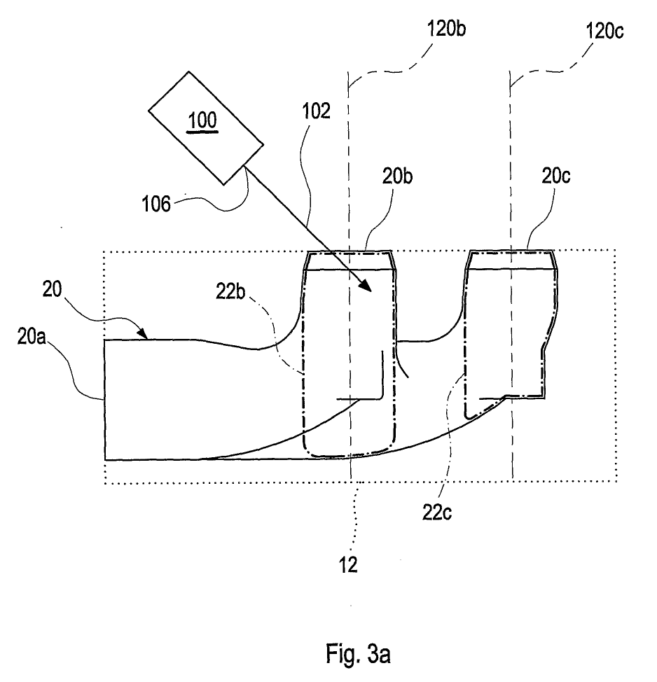

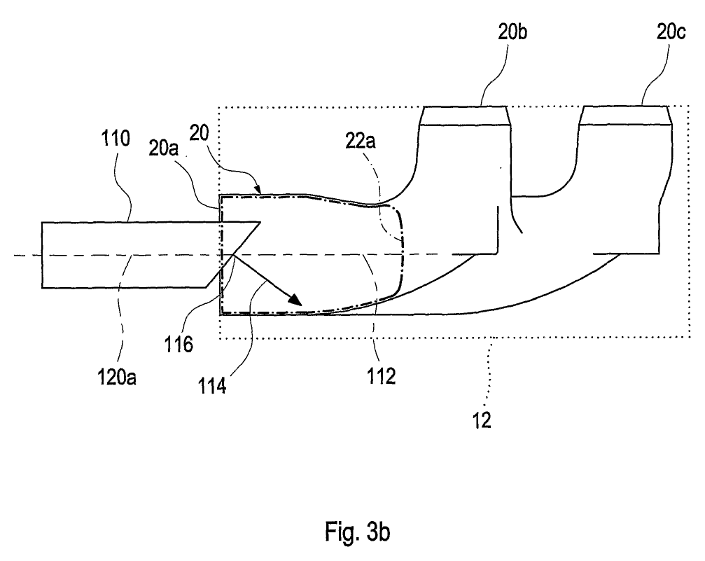

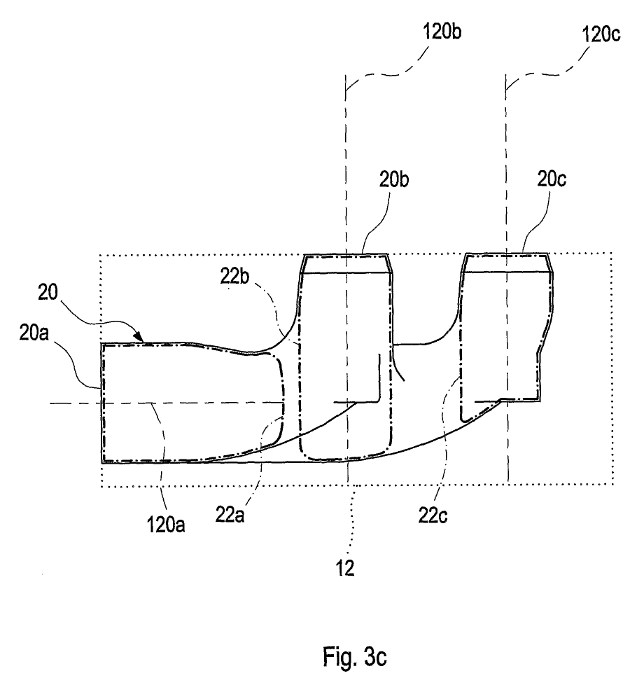

Referring now to the illustrations in FIGS. 2a, 2b in combination with FIGS. 3a, 3b, the fire face side 32 and the exhaust manifold side 36 are oriented perpendicular to each other, the exhaust ports 20 have two portions 22b, 22c and 22a which are bent between the perpendicularly oriented fire face side 32 and the exhaust manifold side 36. The two portions 22b, 22c at the fire face side 32 are merged into the portion 22a at the exhaust manifold side 36, which can be more clearly seen in FIGS. 3a 3b and 3c.

A longitudinal cut through an exhaust port 20 is depicted in FIG. 3a and FIG. 3b with a first spray gun 100 depositing material on a first surface portion 22b, 22c of the exhaust port 20 (FIG. 3a) and with a second spray gun 110 depositing material on a second surface portion 22a of the exhaust port 20 (FIG. 3b). FIG. 3c illustrates the first surface portions 22b, 22c and the second surface portion 22a of the exhaust port 20 to be coated in combination. According to the example embodiment of FIG. 3c, the first and second portions 22b, 22c and 22a can be spray coated simultaneously.

A nozzle 106 of the spray gun 100 coating the first portion 22b, 22c is positioned outside the exhaust port 20 under an angle to the walls of the exhaust port 20 to deposit material inside the first portions 22b, 22c of the exhaust ports 20 (FIG. 3a). The material from the first spray gun 100 is deposited along a direction 102 corresponding to a longitudinal extension of the first pray gun 100. The first spray gun 100 can be rotated about an axis 102b in the first of the first portions 20b and about an axis 120c in the second of the first portions 20c. The axes 120b, 120c are virtually parallel to the walls close to the openings 20b, 20c of the two first portions 22b, 22c.

The slash-dotted lines in the two first portions 22b, 22c indicate the surface areas where the material from the spray gun 100 can be deposited. Preferably, the spray gun 100 is operated by a robot unit (not shown) for precise control of the deposition of the thermal insulating coating.

The two first portions 22b, 22c can be coated with one first spray gun 100 sequentially or with two first spray guns 100 simultaneously.

FIG. 3b illustrates how the coating in the second portion 22a of the exhaust port 20 is performed. The second portion 22a of the exhaust port 20 is coated by material supplied by a second spray gun 110. The material sprayed by the second spray gun 110 is supplied from a nozzle 116 arranged inside of the exhaust port 20, wherein the material coating the second portion 22a is deposited in a direction 114 arranged under an angle to a direction 112 corresponding to a longitudinal extension of the second spray gun 110.

The second spray gun 110 is positioned virtually parallel to the walls close to the opening 20a of the second portion 22a. By rotating the second spray gun 110 about an axis 120a the second portion 22a of the exhaust ports 20 can be coated. The axis 120a is arranged parallel to the direction 112. Preferably, the second spray gun 110 is operated by a robot unit (not shown) for precise control of the deposition of the thermal insulating coating.

Favourably, the coating of each portion 22a and 22b, 22c can be performed in a compact process. Preferably, a surface treatment step is performed prior to the coating step. By way of example, the surfaces to be coated can be treated with grit blasting or the like. In a subsequent optional step, a first coating can be applied for improving the bond strength of the thermal insulation coating by depositing a bond coat layer, e.g. a metal based layer via the spray guns 100 and 110. The thickness of the optional bond coat layer can be in the range of a few micrometers to a few tens of micrometers.

After the bond coat deposition or after the surface treatment step, if no bond coat layer is applied, the topcoat layer is deposited in the above mentioned way.

Preferably, the topcoat layer can deposited in the two first portions 22b, 22c with a high deposition rate and in the second portion 22a with a lower deposition rate as the sizes of the spray guns 100, 110 differ: since the spray gun 110 used for coating portion 22a is much smaller to fit in the port 20a, it may have less available power to melt the coating particles, as well as a lower powder feed. For instance, in a test power for the portion 22a can reach approximately 6 kW, compared with 40 kW for the portions 22b and 22c.

Advantageously, the topcoat layer can be deposited with thicknesses up to several hundreds of micrometers which result in a favourable thermal insulation of the hot exhaust gases.

By providing a thermal insulating barrier between the hot exhaust gases and the cylinder head 12 it is possible to increase the exhaust gas temperature at the exit of the cylinder head 13 by reducing the heat losses to the cylinder head 12 and its coolant. Thus, the power available in the turbocharger 50 (FIG. 1) can be increased. As a consequence, the fuel consumption of the engine 10 can be decreased.

1. A method for coating at least one exhaust port of a cylinder arranged inside a cylinder head of a combustion engine, wherein the exhaust port connects the cylinder to an exhaust system, one or more surface portions of the cylinder head defining the at least one exhaust port are at least partially coated by spraying material from both the cylinder side and the exhaust system side.

2. The method according to claim 1, coating separately a first portion and a second portion of the exhaust port.

3. The method according to claim 1, the first portion of the exhaust port is coated by material supplied by a first spray gun.

4. The method according to claim 3, a nozzle of the spray gun coating the first portion is positioned outside the exhaust port.

5. The method according to claim 1, the second portion of the exhaust port is coated by material supplied by a second spray gun.

6. The method according to claim 5, supplying the material from a position inside the exhaust port.

7. The method according to claim 1, the first and/or the second spray gun is rotated about an axis (120b, 120c; 120a) during spray coating.

8. The method according to claim 1, the material coating the first portion is deposited with a deposition rate higher than the material coating the second portion.

9. The method according to claim 1, the first portion on the cylinder head fire face side is coated with a deposition rate higher than coating the second portion on an exhaust manifold side of the exhaust port.

10. An apparatus for performing the method according to claim 1, comprising a first spray gun and a second spray gun for deposition of a material at a first and a second portion of an exhaust port of a cylinder head.

11. The apparatus according to claim 10, a nozzle of the first spray gun is arranged to deposit material along a direction (102) corresponding to a longitudinal extension of the first spray gun.

12. The apparatus according to claim 10, a nozzle of the second spray gun is arranged to deposit material under an angle to a direction corresponding to a longitudinal extension of the second spray gun.

13. The apparatus according to claim 10, the first and/or the second spray guns are arranged rotatably with respect to the exhaust port.

14. The apparatus according to claim 10, the first and/or the second spray guns are arranged rotatably with respect to the exhaust port.

15. A cylinder head comprising at least one exhaust port coated with a method according to claim 1.

16. A method for coating at least one exhaust port of a cylinder arranged inside a cylinder head of a combustion engine, wherein the exhaust port connects the cylinder to an exhaust system, and wherein one or more surface portions of the cylinder head defining the at least one exhaust port are at least partially coated by spraying material from both the cylinder side and the exhaust system side.

17. The method according to claim 16, wherein a first portion and a second portion of the exhaust port are coated separately.

18. The method according to claim 16, wherein the first portion of the exhaust port is coated by material supplied by a first spray gun.

19. The method according to claim 18, wherein a nozzle of the spray gun coating the first portion is positioned outside the exhaust port.

20. (Original The method according to claim 16, wherein the second portion of the exhaust port is coated by material supplied by a second spray gun.

21. The method according to claim 20, wherein the material is supplied from a position inside the exhaust port.

22. The method according to claim 16, wherein the first and/or the second spray gun is rotated about an axis during spray coating.

23. The method according to claim 16, wherein the material coating the first portion is deposited with a deposition rate higher than the material coating the second portion.

24. The method according to claim 16, wherein the first portion on the cylinder head fire face side is coated with a deposition rate higher than coating the second portion on an exhaust manifold side of the exhaust port.

25. An apparatus for performing the method according to claim 16, wherein a first spray gun and a second spray gun are provided for deposition of a material at a first and a second portion of an exhaust port of a cylinder head.

26. The apparatus according to claim 25, wherein a nozzle of the first spray gun is arranged to deposit material along an axis of a longitudinal extension of the first spray gun.

27. The apparatus according to claim 25, wherein a nozzle of the second spray gun is arranged to deposit material under an angle to an axis of a longitudinal extension of the second spray gun.

28. The apparatus according to claim 25, wherein the first and/or the second spray guns are arranged rotatably with respect to the exhaust port.

29. The apparatus according to claim 25, wherein the first and/or the second spray guns are arranged rotatably with respect to the exhaust port.

30. A cylinder head comprising at least one exhaust port coated with a method according to claim 16.
